(19) United States
(12) Patent Application Publication
(10) Pub. No.: US 2026/0126605 A1
(43) Pub. Date: May 7, 2026

(54) CABLE TAPES AND SPLICES FOR CABLE TAPES

(71) Applicant: Neenah, Inc., Alpharetta, GA (US)

(72) Inventor: Simon Terry, Renfrew (CA)

(21) Appl. No.: 19/379,543

(22) Filed: Nov. 4, 2025

Related U.S. Application Data
(60) Provisional application No. 63/717,382, filed on Nov. 7, 2024.

(51) Int. Cl. G02B 6/44

(52) U.S. Cl. CPC G02B 6/44384

(57) ABSTRACT

Splices for cable tapes are provided herein. Cable tapes, such as water blocking tapes, that include such splices are also provided. The splices and tapes may be incorporated into a tape or cable wrapping for various conductors, including power, telecom, and fiber optic cables. A splice for use with a cable tape comprises a layer of nonwoven fibers. The fibers form a discontinuous adhesive web having a thickness of about 0.15 mm to about 1.0 mm. The discontinuous web structure of the splice is configured to prevent formation of a film in the cable tape. The splice forms a thermal bond with multiple sections of the cable tape while substantially maintaining the thickness of the tape. The splice preferably has a cross web flexibility similar to the cable tape at the elevated temperatures experienced during extrusion, particularly when the tape is applied longitudinally inside a co-extruded tube over the fiber bundle.

### CROSS-REFERENCE TO RELATED APPLICATIONS

This application claims the benefit of U.S. Provisional Application Serial No. 63/717,382, filed November 7, 2024, the complete disclosure of which is incorporated herein by reference for all purposes.

### BACKGROUND

Water swellable, or water blocking, tapes are designed to protect power, telecom, and fiber optic cables from the damaging and corrosive effects of water penetration and migration. When water enters into a cable protected by a water swellable tape, the super-absorbent component within the tape rapidly absorbs the water and quickly swells to block any further ingress. This minimizes and localizes any cable damage due to water and to aid in repair.

In the field of fiber optic cables, a class of cables exist referred to as ribbon cables. These cables require a water blocking tape as a cushion layer and centering layer. The tape is applied longitudinally inside a co-extruded tube over the fiber bundle. The tape must have properties that cushion the fiber from pressure points and must also act as a water blocking element in the event the cable is damaged in service. To make a long enough length of tape, a spooled format is used with splices in the tape. These splices must withstand the temperature and tensile stress of the extrusion process without impacting the extruded tube. The splices must also maintain the parent tape thickness. These splices typically comprise temperature resistant films that are sealed to the gaps along the tape.

Recent developments in fiber optic cable design have resulted in the use of thinner and softer tube materials. It would therefore be desirable to provide improved tape splices that are optimized for use with these new materials.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Splices for cable tapes are provided herein. Cable tapes, such as water blocking tapes, that include such splices are also provided. The splices and tapes may be incorporated into a tape or cable wrapping for various conductors, including power, telecom, and fiber optic cables.

In one aspect, a splice for use with a cable tape comprises a layer of nonwoven fibers. The fibers form a discontinuous adhesive web having a thickness of about 0.15 mm to about 1.0 mm.

The discontinuous web structure of the splice is configured to prevent formation of a film in the tape. The splice preferably has a cross web flexibility similar to the cable tape at the elevated temperatures experienced during extrusion, particularly when the tape is applied longitudinally inside a co-extruded tube over the fiber bundle.

In embodiments, the splice has a thickness of about 0.30 mm to about 0.40 mm, or about 0.35 mm. The thickness is measured according to ISO 9073-2. The splice may have an area density (i.e., mass per unit area in the width and length of the material) of about 20 g/m² to about 40 g/m², or about 25 g/m² to about 35 g/m², or about 30 g/m². The splice may have an apparent density (i.e., mass per unit volume) of about 0.01 g/ml to about 1.0 g/ml, or about 0.03 g/ml to about 0.5 g/ml, or about 0.05 g/ml to about 0.2 g/ml or about 0.08 g/ml to about 0.15 g/ml or about 0.1 g/ml (measured according to ISO 9073-2).

In embodiments, the fibers in the adhesive web comprise a material having a melting temperature at or above the temperature the tape is exposed to during the extrusion process. This temperature may vary depending on the application. In an exemplary embodiment, the material has a melting temperature of least about 100°C, or at least about 150°C, or at least about 200°C. In embodiments, the fibers comprise polyamides, polyesters, co-polyesters, polyethylenes or combinations thereof. In one exemplary embodiment, the fibers comprise polyamide.

In embodiments, the fibers have a maximum dimension, e.g., diameter, of about 0.01 mm to about 0.010 mm, or about 0.02 mm to about 0.06 mm, or about 0.06 mm.

The fibers contemplated may have any suitable shape in cross-section. The fibers may be monocomponent or multicomponent fibers. The fibers may be continuous or stable fibers. the fibers may include additives such as other polymers, nucleating agents, plasticizer, slip additives, elastomeric polymers and the like.

In embodiments, the discontinuous adhesive web is configured to thermally bond to the cable tape without flowing and turning into a film. The splice may have a cross-direction stiffness of less about 60 mN/cm, or less than about 50 mN/cm, or less than about 40 mN/cm or about 32 mN/cm. The cross-direction stiffness is measured in the cross web direction according to ISO 9073-7 (flexural rigidity test).

In embodiments, the cable tape is a water blocking tape. In an exemplary embodiment, the water blocking tape is applied longitudinally to a component of a cable, such as to the inside of a co-extruded tube of a fiber bundle.

In another aspect, a water blocking tape comprises first and second polymers layers, a water swellable layer positioned between the first and second polymer layers and one or more splices in contact with at least one of the polymer layers. The splice(s) each comprise a discontinuous adhesive web of nonwoven fibers.

In embodiments, the splice(s) are thermally bonded to at least one of the first and second polymer layers. In an exemplary embodiment, the splice(s) are thermally bonded to both of the polymer layers.

In embodiments, the splice(s) are configured to substantially maintain the thickness of the water blocking tape. In embodiments, the water blocking tape comprises a first section separated from a second section. The first and second sections are overlapped with the splice and heat and pressure are applied to fuse the three layers while substantially maintaining the thickness of the water blocking tape.

In embodiments, the splice has a thickness of about 0.15 mm to about 1.0 mm, or about 0.30 mm to about 0.40 mm, or about 0.35 mm. The splice may have an area density of about 20 g/m² to about 40 g/m², or about 25 g/m² to about 35 g/m², or about 30 g/m². The splice may have an apparent density of about 0.01 g/ml to about 1.0 g/ml, or about 0.03 g/ml to about 0.5 g/ml, or about 0.05 g/ml to about 0.2 g/ml or about 0.08 g/ml to about 0.15 g/ml or about 0.1 g/ml (measured according to ISO 9073-2).

In embodiments, the fibers in the adhesive web comprise a material having a melting temperature at or above the temperature the tape is exposed to during the extrusion process. This temperature may vary depending on the application. In an exemplary embodiment, the material has a melting temperature of least about 100°C, or at least about 150°C, or at least about 200°C. In embodiments, the fibers comprise polyamides, polyesters, co-polyesters, polyethylenes or combinations thereof.

In an exemplary embodiment, the polymer layers of the water blocking tape each comprise nonwoven fibers chemically bonded to each other and carded to form a web having a thickness of about 0.1 mm to about 1.0 mm, or about 0.2 mm to about 0.5 mm, or about 0.22 mm to about 0.36 mm. The thickness is measured according to ISO 9073-2 when the polymer layers are completely dry (i.e., the water swellable layer is not in contact with water). The polymer layers may have an area density of about 30 g/m² to about 50 g/m², or about 39 g/m² to about 45 g/m². Thus, the overall volumetric density of the polymer layers is reduced, which allows the polymer layers to remain fluffy because the fibers are not permanently compressed during the manufacturing process. The thicker, softer polymer layers provide an increased buffer layer which, in certain embodiments, may serve as protection for cables, such as ribbon cables and the like.

The nonwoven fibers may be selected from any suitable material, such as polyester, nylon or the like. In an exemplary embodiment, the fibers comprise polyester. The fibers may be crimped mechanically to facilitate carding and to increase their thickness and/or fluffiness in the Z-direction, thereby reducing surface contact and friction.

In embodiments, the nonwoven material further comprises a chemical binder selected to have relatively low friction and high heat resistance. This reduces the amount of fiber and powder buildup on the extrusion tooling during the manufacturing process, which reduces rework and downtime, thereby decreasing the overall cost to manufacture the cables. In an exemplary embodiment, the chemical binder comprises a thermoset material, such as polyurethane, polyester, epoxy, silicone, melamine, polyimide, cyanoacrylate phenol resins and the like. The binder may be crosslinked.

In other embodiments, the nonwoven material comprises spun bond and/or wet laid polyester cloth with no binder. In an exemplary embodiment, the polyester cloth is thermoplastic.

In various embodiments, the water swellable layer comprises superabsorbent polymer (SAP) particles, such as crystals, powder, grains, or other granulated material. The SAP particles may comprise any suitable material that swells upon contact with water and compress to fill the polyester layers and form a water seal.

The tape further comprises an adhesive configured to bond the first polymer layer to the second polymer layer. The adhesive may comprise any suitable adhesive, preferably one that is water soluble such that the polymer layers release from each other and spread apart when the tape swells upon contact with water. Suitable water soluble adhesives may comprise starch, dextrin, acrylic, polychloroprene, animal or vegetable glues, polyurethane, polymer acetates, such as polyvinyl acetate (PVA) and ethylene vinyl acetate (EVA), latex, elastomers, rubbers and combinations thereof.

In another aspect, a cable is provided comprising a tape containing one or more splices as described above. The cable may, for example, comprise a fiber optic ribbon cable having a bundle of optical fibers. The tape substantially surrounds the bundle of fibers and provides a water blocking layer between the fibers and other layers or tubes positioned around the tape.

In various embodiments, the cable comprises an outer jacket, an extruded buffer tube and a water swellable tape as described above. The water swellable tape may be constructed such that the buffer tube has an ovality of less than about 2.0 mm, or less than about 1.0 mm.

In another aspect, a fiber optic ribbon cable is provided. The cable comprises a bundle of optical fibers and a water blocking or swellable tape substantially surrounding the optical fibers. The tape comprises first and second polymer layers each comprising a nonwoven polyester material and a water swellable layer positioned between the first and second polymer layers. The tape further comprises a splice in contact with at least one of the polymer layers. The splice comprises a discontinuous adhesive web of nonwoven fibers.

It is to be understood that both the foregoing general description and the following detailed description are exemplary and explanatory only and are not restrictive. Additional features will be set forth in part in the description which follows or may be learned by practice of the description.

### BRIEF DESCRIPTION OF THE DRAWINGS

The accompanying drawings, which are incorporated in and constitute a part of this specification, illustrate several embodiments, and serve to explain the principles herein.

FIG. 1 schematically depicts nonwoven fibers that may be used to form a discontinuous adhesive web for a splice;

FIG. 2 schematically depicts a water blocking tape for use with the splice of FIG. 1;

FIG. 3 schematically depicts a cross-sectional view of an exemplary optical fiber cable with the tape of FIG. 2;

FIG. 4 is a partial cut-a-way view of a representative fiber optic ribbon cable;

FIG. 5 is a cross-sectional view of the cable of FIG. 4;

FIG. 6 is partial cut-a-way view of another representative fiber optic ribbon cable; and

FIG. 7 is a partial cut-a-way view of another representative fiber optic ribbon cable.

### DETAILED DESCRIPTION

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

In accordance with one aspect of this description, splices for cable tapes are provided herein. Cable tapes, such as water blocking tapes, that include such splices are also provided. The splices and tapes may be incorporated into a tape or cable wrapping for various conductors, including power, telecom, and fiber optic cables. In an exemplary embodiment, water swellable tapes including one or more splices are provided for use with fiber optic ribbon cables. As used herein, the term “splice” refers to a joint, connection, or overlap region where two or more segments of a tape, web, or layer are joined together to form a continuous length. In the context of water-swellable tapes for fiber optic ribbon cables, the splice serves to connect adjacent portions of the tape material—for example, when the tape is manufactured, cut, or joined during processing—while maintaining functional integrity such as flexibility, adhesion, and water-blocking performance.

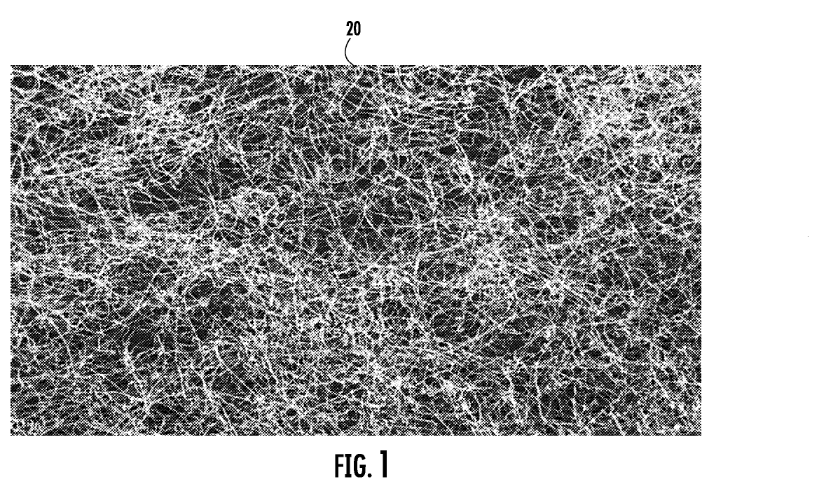

Referring to FIG. 1, a splice for use with a cable tape comprises a plurality of nonwoven fibers 20. The nonwoven fibers 20 are configured to form a discontinuous adhesive web having a thickness of about 0.15 mm to about 1.0 mm. The term “discontinuous”, as used herein, refers to an adhesive web or layer that is not a solid, unbroken film but instead contains multiple interruptions or voids throughout its structure. These interruptions may take the form of intervals, gaps, spaces, holes, apertures, or pores that extend in the Z-direction, meaning through the thickness of the adhesive layer. In other words, the adhesive material does not form a completely continuous coating across its entire surface area when viewed in cross-section.

Because of these discontinuities, the adhesive web exhibits regions without adhesive material, allowing the underlying substrate (for example, a cable tape) to bend, flex, or elongate more easily. This structural characteristic prevents the splice from behaving like a rigid sheet and instead imparts enhanced conformability and flexibility to the splice once applied. In practical terms, a discontinuous adhesive web may be formed by pattern-coating, screen-printing, perforating, or foaming the adhesive so that discrete adhesive islands or networks are created rather than a uniform film. The resulting pattern can improve not only flexibility but also properties such as breathability, moisture vapor transmission, and reduced stiffness—all of which are desirable when the adhesive is used to splice flexible materials like cable tapes, films, or laminates.

In embodiments, the discontinuous adhesive web is configured to thermally bond to the cable tape without flowing and turning into a film. The specific dimensions of the discontinuities in the splice will vary based on the application, the materials of the fibers, the method of manufacturing the fibers and other factors. The discontinuous adhesive web of the splice may also be characterized in terms of its porosity or the ratio of the volume of the pores to the total volume of the web. In certain embodiments, the adhesive web may comprise a porosity of at least about 1%, or at least about 5% or at least about 10%, or at least about 25%. In some embodiments, the porosity may be 50% or greater.

In an exemplary embodiment, the discontinuities are selected such that the splice preferably has a cross web flexibility similar to the cable tape at the elevated temperatures experienced during extrusion, particularly when the tape is applied longitudinally inside a co-extruded tube over the fiber bundle. The splice may have a cross-direction stiffness of less than about 60 mN/cm, or less than about 50 mN/cm, or less than about 40 mN/cm or about 32 mN/cm. In some embodiments, the splice may be used with a cable tape, such as a water blocking tape, having a cross-direction stiffness of about 2 mN/cm to about 20 mN/cm, or 5 mN/cm to about 15 mN/cm or about 9 mN/cm. The cross-direction stiffness was measured in the cross web direction according to ISO 9073-7.

In embodiments, the splice has a thickness of about 0.15 mm to about 1.0 mm, or about 0.30 mm to about 0.40 mm, or about 0.35 mm. The splice may have an area density of about 20 g/m² to about 40 g/m², or about 25 g/m² to about 35 g/m², or about 30 g/m². The splice may have an apparent density of about 0.01 gm/ml to about 1.0 g/ml, or about 0.03 g/ml to about 0.5 g/ml, or about 0.05 g/ml to about 0.2 g/ml or about 0.08 g/ml to about 0.15 g/ml or about 0.1 g/ml (measured according to ISO 9073-2).

The term “apparent density” refers to the mass of the splice per unit of its apparent (bulk) volume, including both the solid components (e.g., adhesive fibers, fillers, and nonwoven matrix) and the internal voids, pores, or air spaces within the structure. In other words, it describes how much material is present per unit volume as the structure exists in its assembled, porous form, not after compression or removal of voids. In this case, the apparent density of the splice indicates how compact or open the discontinuous adhesive web is — a lower apparent density corresponds to a more open, porous, and flexible web, while a higher apparent density corresponds to a denser, more compact structure. This parameter is particularly useful for characterizing nonwoven or fibrous adhesive webs like those used in splices, since their structure includes significant air volume and cannot be described accurately by true material density alone. The apparent density is determined in accordance with ISO 9073-2, which defines the method for measuring the mass per unit area and thickness of nonwoven fabrics.

In embodiments, the fibers 20 in the adhesive web comprise a material having a melting temperature at or above the temperature the tape is exposed to during the extrusion process. This temperature may vary depending on the application. In an exemplary embodiment, the material has a melting temperature of least about 100°C, or at least about 150°C, or at least about 200°C. In embodiments, the fibers comprise polyamides, polyesters, co-polyesters, polyethylenes or combinations thereof. In an exemplary embodiment, the fibers comprise polyamide.

In embodiments, the fibers have a maximum dimension, e.g., diameter, of about 0.01 mm to about 0.010 mm, or about 0.02 mm to about 0.06 mm, or about 0.06 mm.

The fibers contemplated may have any suitable shape in cross-section, including without limitation, circular, kidney bean, dog bone, trilobal, barbell, bowtie, star, Y-shaped, triangular, multilobal, square, oval and others. These shapes and/or other conventional shapes may be used with any of the embodiments described herein to obtain the desired performance characteristics.

The fibers may be manufactured by any suitable method, including, without limitation, meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or the like.

The fibers may be monocomponent or multicomponent fibers. The multicomponent fibers may have any suitable configuration such as concentric core/sheath, eccentric core/sheath, side by side, segmented pie, segmented cross, segmented ribbon, island in the sea, hollow bicomponent fiber. hollow segmented pie, trilobal, tipped multilobal, mixed fibers, striped fibers, conductive fibers, and combinations thereof. In an exemplary embodiment, the fibers are monocomponent fibers.

The fibers may be continuous or stable fibers. In an exemplary embodiment, the fibers are staples fibers and may have a length of about 30 mm to about 50 mm, or about 35 mm to about 40 mm.

In various embodiments, the fibers may include additives such as other polymers, nucleating agents, plasticizer, slip additives, elastomeric polymers and the like.

The fibers may be manufactured by any suitable method, including, without limitation, meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or the like. In an exemplary embodiment, the fibers are formed from a spun bond process.

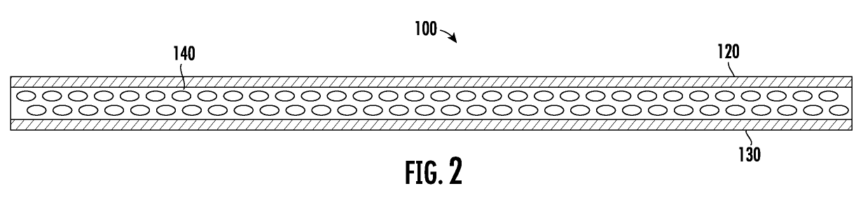

Referring to FIG. 2, a water blocking or water swellable tape 100 for use with a splice (see FIG. 1) comprises first and second polymer layers 120, 130 and a water swellable material 140 therebetween. Tape 100 may include one, two, or three or more splices 10 depending on the overall length of the tape and the parameters of the manufacturing process, such as the length of tape 100 for each spool (not shown). In certain embodiments, a splice may be applied to the tape every 200 meters, or every 500 meters, or every 1,000 meters, or every 2,000 meters or longer. The splice(s) 10 are thermally bonded to at least one of the first and second polymer layers 120, 130 while substantially maintaining the thickness of the water blocking tape 100. In an exemplary embodiment, the splice(s) 10 are thermally bonded to both of the polymer layers 120, 130.

Tape 100 further comprises an adhesive (not shown) for bonding layers 120, 130 together. The adhesive may be positioned in contact with layers 120, 130 and/or within water swellable material 140.

In an exemplary embodiment, polymer layers 120, 130 preferably comprise a nonwoven material which may comprise a substrate, sheet, layer, film, web, or other media comprising fibers, preferably comprising a material that substantially retains water swellable material 140 within layers 120, 130 when the material swells up on contact with water. The nonwoven material may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film.

The fibers may be manufactured by any suitable method, including, without limitation, meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or the like.

In an exemplary embodiment, the polymer layers 120, 130 comprise nonwoven fibers chemically bonded to each other and carded to form a web having a thickness of about 0.1 mm to about 1.0 mm, or about 0.2 mm to about 0.5 mm, or about 0.22 mm to about 0.36 mm. The thickness is measured according to ISO 9073-2 when the polymer layers 120, 130 are completely dry (i.e., the water swellable layer is not in contact with water). The polymer layers may have an area density or mass per unit area of about 30 g/m² to about 50 g/m², or about 39 g/m² to about 45 g/m². Thus, the overall volumetric density of the polymer layers is reduced. This design allows the polymer layers to remain fluffy because the fibers are not permanently compressed during the manufacturing process. The thicker, softer polymer layers provide an increased buffer layer which, in certain embodiments, may serve as protection for cables, such as ribbon cables and the like.

The fibers contemplated may have any suitable shape in cross-section, including without limitation, circular, kidney bean, dog bone, trilobal, barbell, bowtie, star, Y-shaped, triangular, multilobal, square, oval and others. These shapes and/or other conventional shapes may be used with any of the embodiments described herein to obtain the desired performance characteristics.

The nonwoven fibers may be selected from any suitable material, such as polyester, nylon or the like. In an exemplary embodiment, the fibers comprise polyester. The fibers may be crimped mechanically to facilitate carding and to increase their thickness or fluffiness in the Z-direction.

The polyester fibers may be continuous or stable fibers. In an exemplary embodiment, the fibers are staples fibers and may have a length of about 30 mm to about 50 mm, or about 35 mm to about 40 mm.

The fibers may be monocomponent or multicomponent fibers. The multicomponent fibers may have any suitable configuration such as concentric core/sheath, eccentric core/sheath, side by side, segmented pie, segmented cross, segmented ribbon, island in the sea, hollow bicomponent fiber. hollow segmented pie, trilobal, tipped multilobal, mixed fibers, striped fibers, conductive fibers, and combinations thereof. In an exemplary embodiment, the fibers are monocomponent fibers.

The fibers may have thicknesses that are suitable for the application. In some embodiments, the fibers have a linear density of about 0.5 denier to about 2.0 denier or about 1.0 denier to about 1.5 denier. In certain embodiments, the fibers may be selected to have a machine direction (MD) orientation of about 70% to about 95% or about 80% to about 90%.

In various embodiments, the fibers may include additives such as other polymers, nucleating agents, plasticizer, slip additives, elastomeric polymers and the like.

In embodiments, the nonwoven material further comprises a chemical binder selected to have relatively low friction and high heat resistance. This reduces the amount of fiber and powder buildup on the extrusion tooling during the manufacturing process, which reduces rework and downtime, thereby decreasing the overall cost to manufacture the cables. In an exemplary embodiment, the chemical binder comprises a thermoset material, such as polyurethane, polyester, epoxy, silicone, melamine, polyimide, cyanoacrylate phenol resins and the like. The binder may be crosslinked.

In other embodiments, the nonwoven material comprises spun bond and/or wet laid polyester cloth with no binder. In an exemplary embodiment, the polyester cloth is thermoplastic.

The tape further comprises an adhesive in contact with the first and second polymer layers. The adhesive functions to bond first polymer layer 120 to second polymer layer 130 and may comprise any suitable adhesive, preferably one that is water soluble such that the polymer layers release from each other and spread apart when the tape swells upon contact with water. Suitable water soluble adhesives may comprise starch, dextrin, acrylic, polychloroprene, animal or vegetable glues, polyurethane, polymer acetates, such as polyvinyl acetate (PVA) and ethylene vinyl acetate (EVA), latex, elastomers, rubbers and combinations thereof.

Water swellable material 140 preferably comprises a superabsorbent polymer (SAP). SAPs are a class of polymers that are able to absorb large amount of water. Generally speaking, SAPs consist of a network of cross-linked polymer chains that diffuse water within the polymer network where it is stored. The type and degree of crosslinking governs the ability of the superabsorbent polymer to absorb and retain a large volume of water. Examples of suitable superabsorbent polymers are water borne solutions of acrylate polymers and prepolymers formed from water soluble monomers such as acrylic, meth acrylic acid, and 2-acrylamide (DAA) 2-methylpropanesulfuric acid. Other co-monomers such as acrylamide and N-isopropyl acrylamide can also be incorporated into the SAP. Examples of cross-linkers include a variety of multifunctional monomers. They can be di-, tri-, or tetrafunctional, and can have mixed type of polymerizable groups such as methacrylate.

According to one embodiment, the crosslinked superabsorbent polymeric matrix is a cross-linked sodium acrylate polymer that may be, for example, in the form of particles, such as crystals, powder or another granulated substance. In embodiments, the SAP particles have a maximum dimension of less than about 160 microns, or about 75 microns to about 160 microns. In embodiments, the SAP particles are formed through suspension polymerization to create substantially smooth outer surfaces, which reduces signal loss that may otherwise occur with non-smooth surfaces. In an exemplary embodiment, the SAP particles are substantially round or spherical.

In another embodiment, the SAP particles may comprise cross-linked sodium acrylate polymer formed by applying a water-based sodium acrylate polymer or pre-polymer (i.e., liquid SAP) to a substrate and curing by application of heat. When cured, the acrylate polymer or pre-polymer undergoes chemical crosslinking to form the crosslinked superabsorbent polymeric matrix. Suitable water borne solutions of acrylate polymers include Aquaswell 50, Aquaswell 75, and Aquaswell 100, commercially available from H&R ChemPharm (UK) Ltd. (Tipton, West Midlands, United Kingdom). Suitable crosslinked superabsorbent polymers formed on a substrate can also have a binding effect. In one particular embodiment, the liquid SAP may be provided in two parts and mixed prior to use, in order to improve stability in large amounts.

In an alternative embodiment, the water swellable material 140 may be formed as a composite of water-swellable material, fibers, and a water-soluble binder. For example, the material may include water-swellable particulate powder (e.g., SAP powder) and strength-enhancing fibers (e.g., wood pulp) held together with (e.g., embedded. within) a water-soluble binder, such as a polymeric resin (e.g., methyl cellulose resin). Alternative water-soluble binders include polyvinyl alcohol, hydroxyethyl cellulose, ethyl cellulose, cellulose ethers, and latex. In the presence of water, the water-soluble binder will dissolve thereby facilitating the transport of water toward the water-swellable particulate powder. The strength-enhancing fibers within the composite water swellable tape help to ensure that the composite water swellable tape has sufficient strength and structural integrity in the absence of water.

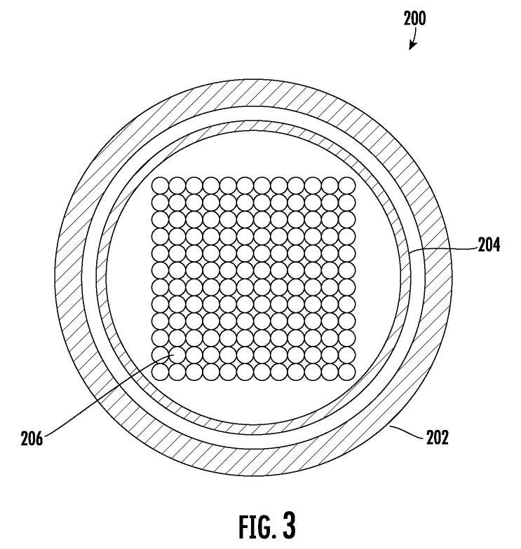

Referring now to FIG. 3, a portion of a cable, such as a fiber optic ribbon cable 200 includes a buffer tube 202, a water swellable tape 204 as described above, and a bundle of fiber optic ribbon cables 206 disposed within tape 204, which includes one or more splices 10 as described above. Ribbon cables 206 may contain conventional glass fibers or bend-insensitive glass fibers. Ribbon cables 206 may include one or more coating layers (e.g., a primary coating and a secondary coating). At least one of the coating layers, typically the secondary coating, may be colored and/or possess other markings to help identify individual fibers. Alternatively, a tertiary ink layer may surround the primary and secondary coatings.

Ribbon cables 206 are typically provided in a bundle and form rows of ribbon cables 206 that may have a substantially square, circular, oval, trapezoidal or rectangular cross-section. In this embodiment, the bundle of ribbon cables is substantially rectangular. Multiple optical fibers may be sandwiched, encapsulated, and/or edge bonded to form an optical-fiber ribbon. Optical fiber ribbons can be divisible into subunits (e.g., a twelve fiber ribbon that is splitable into six-fiber subunits). Moreover, a plurality of such optical-fiber ribbons may be aggregated to form a ribbon stack, which can have various sizes and shapes. A rectangular ribbon stack may be formed with or without a central twist (i.e., a “primary twist'). Those having ordinary skill in the art will appreciate that a ribbon stack is typically manufactured with rotational twist to allow the tube or cable to bend without placing excessive mechanical stress on the optical fibers during winding, installation, and use. In a structural variation, a twisted (or untwisted) rectangular ribbon stack may be further formed into a coil-like configuration (e.g., a helix) or a wave-like configuration (e.g., a sinusoid). In other words, the ribbon stack may possess regular 'secondary deformations.

Tape 204 at least partially encloses optical fibers 206 and preferably completely encloses optical fibers 206. In some embodiments, tape 204 may be in contact with some of the fibers 206 within the bundle, such as the fibers located on the corners of bundle 206. In other embodiments, tape 204 may be spaced from the bundle of fibers 206. Tube 202 surrounds tape 204, although it is contemplated in certain tubeless cable designs that the cable’s outer protective jacket (i.e., sheath) surrounds tape 204 with no intermediate buffer tube located between tape 204 and the cable jacket. In certain embodiments, tape 204 may be bonded to the ribbon cables 206 with an adhesive.

The water swellable tape is constructed such that the buffer tube 202 has an ovality of less than about 2.0 mm, or less than about 1.0 mm. Ovality is defined herein as the difference between the maximum diameter and the minimum diameter of the tape. The relatively low ovality of the tube reduces the pressure applied to the fiber optic cables, particularly in the corners of fiber optic bundles that have a rectangular or square configuration. Reducing the pressure applied by the tube to the fiber optic bundles causes a reduction in the signal loss of the individual optic fibers.

Cable 200 may be manufactured by applying tape 204 longitudinally inside a co-extruded tube over ribbon cables 206. As the tape 204 is applied to the cable, splices 10 are applied to two separate sections of the tape 204, which are formed because the tape 204 on each spool is not long enough to extend across the entire cable 200. In embodiments, the water blocking tape 204 comprises a first section separated from a second section. The first and second sections are overlapped with the splice and heat and pressure are applied to fuse the three layers while substantially maintaining the thickness of the water blocking tape. As discussed above, tape 204 has properties that cushion ribbon cables 206 at pressure points, such as the corners of the bundle of cables 206. Tape 204 is designed to minimize any buildup of fiber or powder on the extrusion tooling, which reduces downtime and rework.

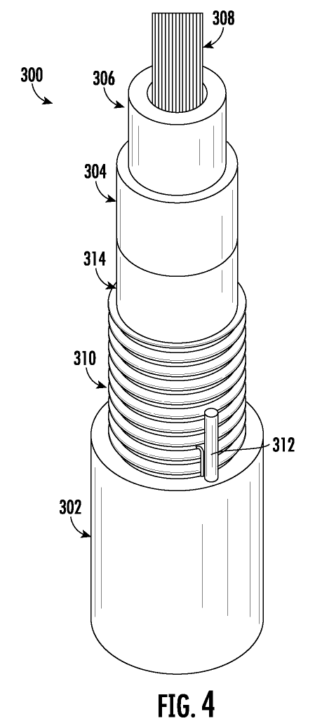

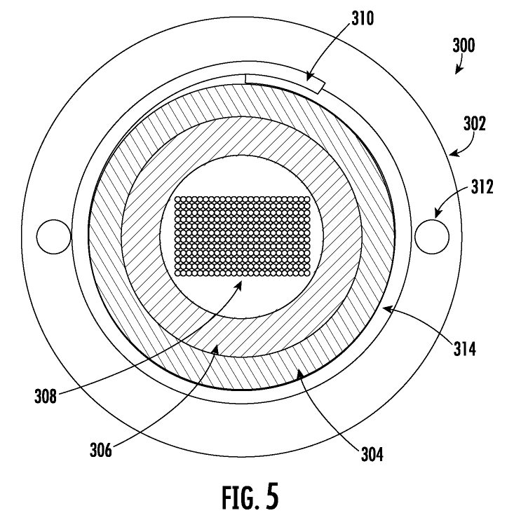

Referring now to FIGS. 4 and 5, a representative fiber optic ribbon cable 300 will now be described. As shown, cable 300 comprises an outer jacket 302, a buffer tube 304, a water swellable tape 306 with one or more splices 10 as described above, and a bundle of fiber optic ribbon cables 308. Jacket 302 and buffer tube 304 may comprise any suitable polymeric material such as, for example, polyethylene, polypropylene, polyvinyl chloride (PVC), polyamides (e.g., nylon), polyester (e.g., PBT), fluorinated plastics (e.g., perfluorethylene propylene, polyvinyl fluoride, or polyvinylidene difluoride), ethylene vinyl acetate (EVA) and combinations thereof. In some embodiments, cable 300 may further include a metal layer 310, such as corrugated steel armor or the like, a ripcord 312 and one or more additional water blocking tapes 314, such as a foam tape or a water swellable tape as described herein.

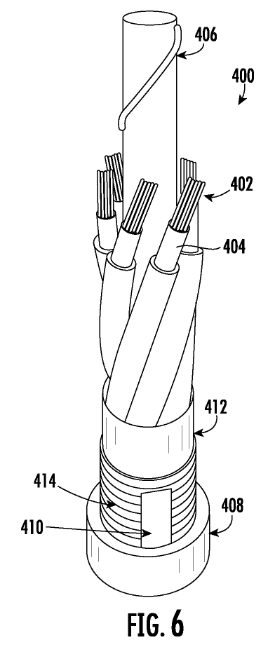

Referring now to FIG. 6, another representative fiber optic ribbon cable 400 generally comprises a plurality of fiber optic bundles 402, which may have any suitable configuration, such as square, rectangular, oval, circular or trapezoidal cross section. In this embodiment, fiber optic bunders 402 are formed into a coil-like configuration (e.g., a helix) to allow cable 400 to bend without placing excessive mechanical stress on the optical fibers during winding, installation, and use. A water swellable tape 404 containing one or more splices 10 surrounds each of the bundles 402. Tape 404 comprises any one of the tapes described herein. Cable 400 may further comprise a water blocking yarn 406 in the form of a circular tube that extends inside of the bundles 402 of ribbon cables. Yarn 406 may comprise a water swellable material, such as those described above. Yarn 406 may also be employed to provide strength to the bundles 402 and may comprise any suitable material, such as aramid, fiberglass, or polyester. In some embodiments, cable 400 includes an outer jacket 408, as described above, a metal layer 414, such as corrugated steel armor or the like, a laminated water blocking tape 410 and another general purpose water blocking tape 412, all surrounding the bundle of cables 402 and water swellable tapes 404.

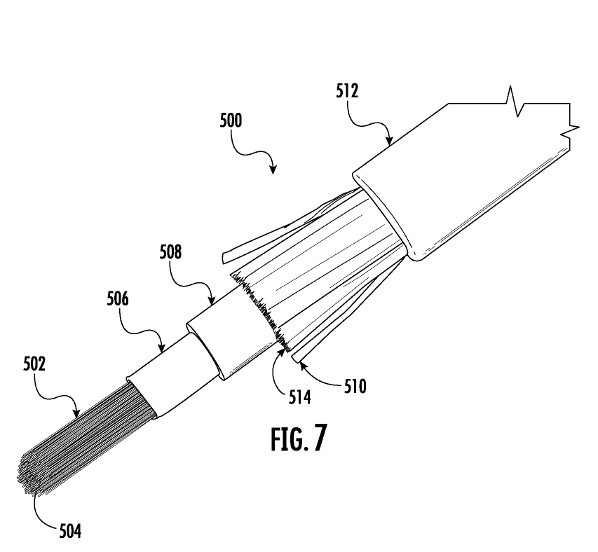

Referring now to FIG. 7, another representative fiber optic ribbon cable 500 generally comprises a bundle 502 of fiber optic cables 504, which are bunched together to form a substantially round shape. A water swellable tape 506 surrounds each of the bundles 502. Tape 506 comprises any one of the tapes described herein and includes one or more splices, as described above. Cable 500 may further comprise an outer jacket 512, a buffer tube 508 and another protective layer 514, that may comprise another general purpose water blocking tape, yarn or the like surrounding the bundle 502 of cables 504 and water blocking tape 506.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a splice for use with a cable tape. The splice comprises a layer of nonwoven fibers. The fibers form a discontinuous adhesive web having a thickness of about 0.15 mm to about 1.0 mm.

A second embodiment is the first embodiment, wherein the thickness is about 0.30 mm to about 0.40 mm.

A third embodiment is any combination of the first two embodiments, wherein the adhesive web has an area density of about 20 g/m² to about 40 g/m².

A 4^{th} embodiment is any combination of the first 3 embodiments, wherein the area density is about 25 g/m² to about 30 g/m².

A 5^{th} embodiment is any combination of the first 4 embodiments, wherein the fibers comprise a material having a melting temperature at or above 150 degrees Celsius.

A 6^{th} embodiment is any combination of the first 5 embodiments, wherein the fibers are selected from the group consisting of polyamides, polyesters, co-polyesters, polyethylenes or combinations thereof.

A 7^{th} embodiment is any combination of the first 6 embodiments, wherein the fibers are formed from a spun bond process.

An 8^{th} embodiment is any combination of the first 7 embodiments, wherein the polymer layer is configured for thermal bonding to a first surface of the tape.

A 9^{th} embodiment is any combination of the first 8 embodiments, wherein the polymer layer is configured for thermal bonding to a second surface of the tape opposite the first surface.

A 10^{th} embodiment is any combination of the first 9 embodiments, wherein the cable tape comprises a water blocking tape.

An 11^{th} embodiment is any combination of the first 10 embodiments, wherein the cable tape is applied along a longitudinal axis of a cable.

A 12^{th} embodiment is any combination of the first 11 embodiments, wherein the adhesive web has an apparent density of about 0.01 g/ml to about 1.0 g/ml.

A 13^{th} embodiment is any combination of the first 12 embodiments, wherein the apparent density is about 0.08 g/ml to about 0.15 g/ml.

A 14^{th} embodiment is any combination of the first 13 embodiments, wherein the splice has a cross-direction stiffness of about 0.01 mN/cm to about 60 mN/cm.

A 15^{th} embodiment is any combination of the first 14 embodiments, wherein the cross-direction stiffness is about 0.01 mN/cm to about 40 mN/cm.

In another aspect, a first embodiment is a water blocking tape comprising first and second polymers layers, a water swellable layer positioned between the first and second polymer layers and a splice in contact with at least one of the polymer layers. The splice comprises a discontinuous adhesive web of nonwoven fibers.

A second embodiment is the first embodiment, wherein the splice is thermally bonded to at least one of the polymer layers.

A third embodiment is any combination of the first two embodiments, wherein the splice is thermally bonded to the first and second polymer layers.

A 4^{th} embodiment is any combination of the first 3 embodiments, wherein the first and second polymer layers and the water swellable layer comprise first and second sections the overlap with each other and the splice.

A 5^{th} embodiment is any combination of the first 4 embodiments, wherein the splice maintains a thickness of the tape.

A 6^{th} embodiment is any combination of the first 5 embodiments, wherein the splice and the first and second sections form three layers that are thermally bonded to each other.

A 7^{th} embodiment is any combination of the first 6 embodiments, wherein the adhesive web has a thickness of about 0.15 mm to about 1.0 mm.

An 8^{th} embodiment is any combination of the first 7 embodiments, wherein the thickness is about 0.30 mm to about 0.40 mm.

A 9^{th} embodiment is any combination of the first 8 embodiments, wherein the adhesive web has an area density of about 20 g/m² to about 40 g/m².

A 10^{th} embodiment is any combination of the first 9 embodiments, wherein the area density is about 25 g/m² to about 30 g/m².

An 11^{th} embodiment is any combination of the first 10 embodiments, wherein the nonwoven fibers comprise a material having a melting temperature at or above 150 degrees Celsius.

A 12^{th} embodiment is any combination of the first 11 embodiments, wherein the fibers are selected from the group consisting of polyamides, polyesters, co-polyesters, polyethylenes or combinations thereof.

A 13^{th} embodiment is any combination of the first 12 embodiments, wherein the fibers are formed from a spun bond process.

A 14^{th} embodiment is any combination of the first 13 embodiments, wherein the polymer layers each comprise a nonwoven material having a thickness of about 0.15 mm to about 1 mm.

A 15^{th} embodiment is any combination of the first 14 embodiments, wherein the thickness is about 0.22 mm to about 0.36 mm.

A 16^{th} embodiment is any combination of the first 15 embodiments, wherein the nonwoven material has an area density of about 30 g/m² to about 50 g/m².

A 17^{th} embodiment is any combination of the first 16 embodiments, wherein the area density is about 39 g/m² to about 45 g/m²

An 18^{th} embodiment is any combination of the first 17 embodiments, wherein the first and second polymer layers comprise a material selected from the group consisting of polyester and nylon.

A 19^{th} embodiment is any combination of the first 18 embodiments, wherein the first and second polymer layers each comprise fibers carded to form a web.

A 20^{th} embodiment is any combination of the first 19 embodiments, further comprising a binder that chemically binds the fibers within each polymer layer to each other.

A 21^{st} embodiment is any combination of the first 20 embodiments, further comprising an adhesive in contact with the first and second polymer layers.

A 22^{nd} embodiment is any combination of the first 21 embodiments, wherein the adhesive comprises a water soluble adhesive.

A 23^{rd} embodiment is any combination of the first 22 embodiments, wherein the water swellable layer comprises water absorbent particles.

A 24^{th} embodiment is any combination of the first 23 embodiments, wherein the adhesive web has an apparent density of about 0.01 g/ml to about 1.0 g/ml.

A 25^{th} embodiment is any combination of the first 24 embodiments, wherein the apparent density is about 0.08 g/ml to about 0.15 g/ml.

A 26^{th} embodiment is any combination of the first 25 embodiments, wherein the splice has a cross-direction stiffness of about 0.01 mN/cm to about 60 mN/cm.

A 27^{th} embodiment is any combination of the first 26 embodiments, wherein the cross-direction stiffness is about 0.01 mN/cm to about 40 mN/cm.

In another aspect, a first embodiment is cable comprising the tape of any of the above 26 embodiments.

A second embodiment is the first embodiment, further comprising a plurality of optical fibers, wherein the tape substantially surrounds the optical fibers.

In another aspect, a first embodiment is a fiber optic ribbon comprising the tape of any of the above 26 embodiments.

A second embodiment is the first embodiment, wherein the tape contacts at least one optical fiber.

A third embodiment is any combination of the first two embodiments, further comprising an outer jacket substantially surrounding the tape.

What is claimed is:

1. A splice for use with a cable tape, the splice comprising:
a layer of nonwoven fibers; and
wherein the fibers form a discontinuous adhesive web having a thickness of about 0.15 mm to about 1.0 mm.

2. The splice of claim 1, wherein the thickness is about 0.30 mm to about 0.40 mm.

3. The splice of claim 1, wherein the adhesive web has an area density of about 20 g/m² to about 40 g/m².

4. The splice of claim 1, wherein the adhesive web has an apparent density of about 0.01 g/ml to about 1.0 g/ml.

5. The splice of claim 1, wherein the splice has a cross-direction stiffness of about 0.01 mN/cm to about 60 mN/cm.

6. The splice of claim 1, wherein the fibers comprise a material having a melting temperature at or above 150 degrees Celsius.

7. The splice of claim 1, wherein the layer is configured for thermal bonding to a first surface of the tape.

8. The splice of claim 7, wherein the layer is configured for thermal bonding to a second surface of the tape opposite the first surface.

9. The splice of claim 1, wherein the cable tape comprises a water blocking tape.

10. The splice of claim 1, wherein the cable tape is applied along a longitudinal axis of a cable.

11. A water blocking tape comprising:
first and second polymers layers;
a water swellable layer positioned between the first and second polymer layers; and
a splice in contact with at least one of the polymer layers, the splice comprising a discontinuous adhesive web of nonwoven fibers.

12. The water blocking tape of claim 11, wherein the splice is thermally bonded to at least one of the polymer layers.

13. The water blocking tape of claim 11, wherein the first and second polymer layers and the water swellable layer comprise first and second sections that overlap with each other and the splice.

14. The water blocking tape of claim 11, wherein the splice and the first and second sections form three layers that are thermally bonded to each other.

15. The water blocking tape of claim 11, wherein the adhesive web has a thickness of about 0.15 mm to about 1.0 mm.

16. The tape of claim 11, wherein the adhesive web has an area density of about 20 g/m² to about 40 g/m².

17. The tape of claim 11, wherein the adhesive web has an apparent density of about 0.01 g/ml to about 1.0 g/ml.

18. The tape of claim 11, wherein the splice has a cross-direction stiffness of about 0.01 mN/cm to about 60 mN/cm.

19. The tape of claim 11, wherein the nonwoven fibers comprise a material having a melting temperature at or above 150 degrees Celsius.

20. The tape of claim 11, wherein the fibers are selected from the group consisting of polyamides, polyesters, co-polyesters, polyethylenes or combinations thereof.
